(19) United States
(12) Patent Application Publication
(10) Pub. No.: US 2022/0368173 A1
(43) Pub. Date: Nov. 17, 2022

(54) POWER SUPPLY CONTROL DEVICE, POWER SUPPLY APPARATUS, AND INPUT/OUTPUT DEVICE

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Hiroya CHIBA, Susono-shi (JP); Shuntaro OKAZAKI, Shizuoka-ken (JP); Shogo TSUGE, Fuji-shi (JP); Kazuhisa MATSUDA, Shizuoka-ken (JP)

(21) Appl. No.: 17/739,175

(22) Filed: May 9, 2022

(30) Foreign Application Priority Data
May 13, 2021 (JP) 2021-081595

(51) Int. Cl. H02J 50/80; B60L 53/126; B60L 58/12; H02J 50/90; B60L 53/60

(52) U.S. Cl. CPC H02J 50/80; B60L 53/126; B60L 58/12; H02J 50/90; B60L 53/60; B60L 2250/00

(57) ABSTRACT

The power supply control device includes a processor configured to request noncontact power supply from the power supply apparatus to the vehicle; confirm an intention to utilize a noncontact power supply with an occupant of the vehicle, and stop the request for noncontact power supply if the occupant does not have the intention to utilize.

### FIELD

The present disclosure relates to a power supply control device, a power supply apparatus, and an input/output device.

### BACKGROUND

Known in the past has been the art of transferring electric power between a power supply apparatus provided on the ground and a vehicle by a noncontact means. For example, PTL 1 describes transmitting a power supply request from a vehicle to a power supply apparatus wirelessly and supplying power from the power supply apparatus to the vehicle by a noncontact means in accordance with the power supply request.

### CITATIONS LIST

### Patent Literature

[PTL 1] Japanese Unexamined Patent Publication No. 2018-157686

### SUMMARY

### Technical Problem

However, when a vehicle passes over a power supply apparatus, an occupant of the vehicle (for example, the driver) will not always desire the battery be charged by noncontact power supply. For example, if the amount of stored power of the battery is sufficient or if charging of the battery by an outside power source or regenerated power is scheduled, there is low need for supplying power from the power supply apparatus to the vehicle. In particular, when a charge is levied for utilization of a noncontact power supply of a vehicle, it is desirable to avoid needless power supply as much as possible.

Therefore, in consideration of the above technical problem, an object of the present disclosure is to keep noncontact supply of power to a vehicle from a power supply apparatus from being performed against the wish of an occupant of the vehicle.

### Solution to Problem

The summary of the present disclosure is as follows.

(1) A power supply control device provided at a vehicle configured to be supplied with power from a power supply apparatus by a noncontact means, comprising: a power supply request part configured to request noncontact power supply from the power supply apparatus to the vehicle; and an intention confirming part configured to confirm an intention to utilize a noncontact power supply with an occupant of the vehicle, wherein the power supply request part is configured to stop the request for noncontact power supply if the occupant does not have the intention to utilize.

(2) The power supply control device described in above (1), wherein when confirming the intention to utilize with the occupant, the intention confirming part is configured to notify the occupant of information relating to a state of charge of a battery of the vehicle.

(3) The power supply control device described in above (2), wherein when confirming the intention to utilize with the occupant, the intention confirming part is configured to notify the occupant of a current state of charge of the battery.

(4) The power supply control device described in above (2) or (3), wherein when confirming the intention to utilize with the occupant, the intention confirming part is configured to notify the occupant of at least one of a distance to a predetermined charging facility and a predicted amount of consumption of power consumed until the vehicle reaches the predetermined charging facility.

(5) A power supply apparatus configured to supply power to a vehicle by a noncontact means, comprising: a control part configured to control noncontact power supply from a power supply apparatus to the vehicle, wherein the control part is configured to stop the noncontact power supply when receiving a signal indicating an occupant of the vehicle has no intention to utilize noncontact power supply.

(6) An input/output device provided in a vehicle configured to be supplied with power from a power supply apparatus by a noncontact means, the input/output device outputting at least one of a screen and a voice for confirming an intention to utilize a noncontact power supply from the power supply apparatus to the vehicle with an occupant of the vehicle.

According to the present disclosure, it is possible to keep noncontact supply of power to a vehicle from a power supply apparatus from being performed against the wish of an occupant of the vehicle.

### BRIEF DESCRIPTION OF DRAWINGS

FIG. 1 is a view schematically showing a configuration of a noncontact power supply system according to a first embodiment of the present disclosure.

FIG. 2 is a schematic view of the configuration of a controller of a power supply apparatus.

FIG. 3 is a view showing the schematic configuration of an ECU of a vehicle and other vehicle-mounted equipment.

FIG. 4 is a functional block diagram of a processor of the ECU.

FIG. 5 is a flow chart showing a control routine of processing for requesting power supply in the first embodiment of the present disclosure.

FIG. 6 is a view showing one example of a screen for confirming an intention to utilize a noncontact power supply with an occupant of a vehicle.

FIG. 7 is a flow chart showing a control routine of processing for power supply in the first embodiment of the present disclosure.

FIG. 8 is a view showing one example of a screen for confirming an intention to utilize a noncontact power supply with an occupant of a vehicle.

FIG. 9 is a flow chart showing a control routine of processing for stopping power supply in a third embodiment of the present disclosure.

FIG. 10 is a flow chart showing a control routine of processing for power supply in the third embodiment of the present disclosure.

### DESCRIPTION OF EMBODIMENTS

Below, referring to the drawings, embodiments of the present disclosure will be explained in detail. Note that, in the following explanation, similar component elements will be assigned the same reference notations.

### First Embodiment

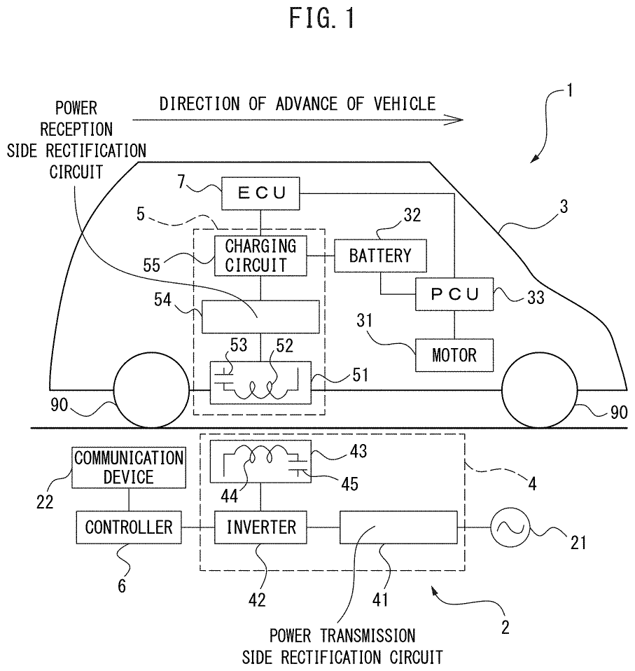

Below, referring to FIG. 1 to FIG. 7, a first embodiment of the present disclosure will be explained.

FIG. 1 is a view schematically showing a configuration of a noncontact power supply system 1 according to the first embodiment of the present disclosure. The noncontact power supply system 1 is provided with a power supply apparatus 2 provided on the ground and a vehicle 3, and supplies power by a noncontact means between the power supply apparatus 2 and the vehicle 3. In particular, in the present embodiment, when the vehicle 3 is running, the noncontact power supply system 1 uses magnetic field resonance coupling (magnetic field resonance) to supply power by a noncontact means from the power supply apparatus 2 to the vehicle 3. That is, the noncontact power supply system 1 transfers power from the power supply apparatus 2 to the vehicle 3 using a magnetic field as the medium. Note that, noncontact power supply is also called noncontact power transfer, wireless power transfer, or wireless power supply.

The power supply apparatus 2 is configured to supply power to the vehicle 3 by a noncontact means, while the vehicle 3 is configured to be supplied with power from the power supply apparatus 2 by a noncontact means. Specifically, the power supply apparatus 2 is provided with a power transmission apparatus 4 configured to transfer power by a noncontact means, while the vehicle 3 is provided with a power reception apparatus 5 configured to receive power from the power transmission apparatus 4 by a noncontact means.

As shown in FIG. 1, the power supply apparatus 2 is provided with, in addition to the power transmission apparatus 4, a power supply 21, a controller 6, and a communication device 22. In the present embodiment, the power supply apparatus 2 is provided at a road (lane) over which the vehicle 3 will pass, and for example, is buried in the ground (under the road surface). Note that, at least a part of the power supply apparatus 2 (for example, the power supply 21, the controller 6, and the communication device 22) may be arranged on the road surface.

The power supply 21 is the power source of the power transmission apparatus 4 and supplies power to the power transmission apparatus 4. The power supply 21, for example, is a commercial alternating current power supply supplying single-phase alternating current power. Note that, the power supply 21 may be an alternating current power supply supplying three-phase alternating current power etc.

The power transmission apparatus 4 is provided with a power transmission side rectification circuit 41, an inverter 42, and a power transmission side resonance circuit 43. In the power transmission apparatus 4, suitable alternating power (high frequency power) is supplied through the power transmission side rectification circuit 41 and the inverter 42 to the power transmission side resonance circuit 43.

The power transmission side rectification circuit 41 is electrically connected to the power supply 21 and the inverter 42. The power transmission side rectification circuit 41 rectifies the alternating current power supplied from the power supply 21 to direct current power and supplies the direct current power to the inverter 42. The power transmission side rectification circuit 41 is, for example, an AC/DC converter.

The inverter 42 is electrically connected to the power transmission side rectification circuit 41 and the power transmission side resonance circuit 43. The inverter 42 converts the direct current power supplied from the power transmission side rectification circuit 41 to alternating current power (high frequency power) of a frequency higher than the alternating current power of the power supply 21 and supplies the high frequency power to the power transmission side resonance circuit 43.

The power transmission side resonance circuit 43 has a resonator comprised of a coil 44 and capacitor 45. The various parameters of the coil 44 and capacitor 45 (outside diameter and inside diameter of the coil 44, turns of the coil 44, electrostatic capacity of the capacitor 45, etc.) are determined so that the resonance frequency of the power transmission side resonance circuit 43 becomes a predetermined set value. The predetermined set value is, for example, 10 kHz to 100 GHz, and preferably is 85 kHz determined by the SAE TIR J2954 standard as the frequency band for noncontact power supply of vehicles.

The power transmission side resonance circuit 43 is arranged at the center of the lane over which the vehicle 3 passes so that the center of the coil 44 is positioned at the center of the lane. If high frequency power supplied from the inverter 42 is applied to the power transmission side resonance circuit 43, the power transmission side resonance circuit 43 generates an alternating current magnetic field for transmitting the power. Note that, the power supply 21 may be a fuel cell or solar cell or other such alternating current power supply. In this case, the power transmission side rectification circuit 41 may be omitted.

The controller 6 is, for example, a general use computer and performs various control of the power supply apparatus 2. For example, the controller 6 is electrically connected to the inverter 42 of the power transmission apparatus 4 and controls the inverter 42 so as to control the power transmission by the power transmission apparatus 4.

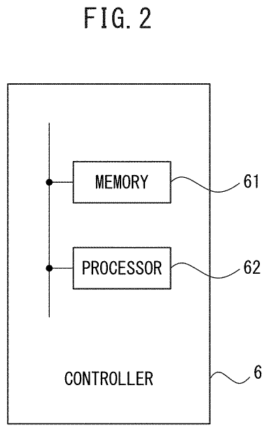

FIG. 2 is a schematic view of the configuration of the controller 6. The controller 6 is provided with a memory 61 and a processor 62. The memory 61 and the processor 62 are connected with each other through signal wires. Note that, the controller 6 may be further provided with a communication interface etc. for connecting the controller 6 to a communication network such as the Internet.

The memory 61 has, for example, a volatile semiconductor memory (for example, a RAM) and a nonvolatile semiconductor memory (for example, a ROM). The memory 61 stores programs to be run at the processor 62 and various data used when various processing is performed by the processor 62.

The processor 62 has one or more CPUs (central processing units) and their peripheral circuits and performs various processing. Note that, the processor 62 may have a logic unit or arithmetic unit or other such processing circuit. The processor 62 is one example of a control part of the power supply apparatus 2.

The communication device 22 is an equipment enabling communication between the power supply apparatus 2 and the outside of the power supply apparatus 2 (for example, near distance wireless communication module). The communication device 22 is electrically connected to the controller 6, and the controller 6 communicates with the vehicle 3 through the communication device 22.

On the other hand, the vehicle 3, as shown in FIG. 1, is provided with, in addition to the power reception apparatus 5, a motor 31, a battery 32, a power control unit (PCU) 33, and an electronic control unit (ECU) 7. In the present embodiment, the vehicle 3 is an electric vehicle (BEV) not mounting an internal combustion engine, and the motor 31 outputs drive power for running use.

The motor 31 is, for example, an alternating current synchronous motor and functions as a motor and a generator. When the motor 31 functions as a motor, the power stored in the battery 32 is used as the source of power for driving it. The output of the motor 31 is transmitted through a decelerator and axle to the wheels 90. On the other hand, at the time of deceleration of the vehicle 3, the motor 31 is driven by rotation of the wheels 90 and the motor 31 functions as a generator to produce regenerated power.

The battery 32 is a rechargeable secondary battery and is, for example, comprised of a lithium ion battery, a nickel-hydrogen battery, etc. The battery 32 stores the power required for the vehicle 3 to run (for example, drive power of motor 31). If the regenerated power produced by the motor 31 is supplied to the battery 32, the battery 32 is charged and the state of charge (SOC) of the battery 32 is restored. Further, the battery 32 can be charged by an outside power supply other than the power supply apparatus 2 through a charging port provided at the vehicle 3.

The PCU 33 is electrically connected to the battery 32 and the motor 31. The PCU 33 has an inverter, a booster converter, and a DC/DC converter. The inverter converts the direct current power supplied from the battery 32 to alternating current power and supplies the alternating current power to the motor 31. On the other hand, the inverter converts the alternating current power generated by the motor 31 (regenerated power) to direct current power and supplies the direct current power to the battery 32. When the power stored in the battery 32 is supplied to the motor 31, the booster converter boosts the voltage of the battery 32 in accordance with need. When the power stored in the battery 32 is supplied to the headlights and other electronic equipment, the DC/DC converter boosts the voltage of the battery 32.

The power reception apparatus 5 is provided with a power reception side resonance circuit 51, a power reception side rectification circuit 54, and a charging circuit 55. The power reception apparatus 5 receives power from the power transmission apparatus 4 and supplies the received power to the battery 32.

The power reception side resonance circuit 51 is arranged at the floor part of the vehicle 3 so that the distance from the road surface becomes smaller. In the present embodiment, the power reception side resonance circuit 51 is arranged at the center of the vehicle 3 in the vehicle width direction and is arranged between the front wheels 90 and the rear wheels 90 in the front-back direction of the vehicle 3.

The power reception side resonance circuit 51 has a configuration similar to the power transmission side resonance circuit 43 and has a resonator comprised of a coil 52 and capacitor 53. The various parameters of the coil 52 and capacitor 53 (outside diameter and inside diameter of the coil 52, turns of the coil 52, electrostatic capacity of the capacitor 53, etc.) are determined so that the resonance frequency of the power reception side resonance circuit 51 matches the resonance frequency of the power transmission side resonance circuit 43. Note that, as long as the amount of deviation of the resonance frequency of the power reception side resonance circuit 51 and the resonance frequency of the power transmission side resonance circuit 43 is small, for example, the resonance frequency of the power reception side resonance circuit 51 is within a range of ±20% of the resonance frequency of the power transmission side resonance circuit 43, the resonance frequency of the power reception side resonance circuit 51 does not necessarily have to match the resonance frequency of the power transmission side resonance circuit 43.

As shown in FIG. 1, when the power reception side resonance circuit 51 faces the power transmission side resonance circuit 43, if an alternating current magnetic field is generated at the power transmission side resonance circuit 43, the vibration of the alternating current magnetic field is transferred to the power reception side resonance circuit 51 which resonates by the same resonance frequency of the power transmission side resonance circuit 43. As a result, due to electromagnetic induction, an induction current flows to the power reception side resonance circuit 51. Due to the induction current, power is generated at the power reception side resonance circuit 51. That is, the power transmission side resonance circuit 43 transmits power through the magnetic field to the power reception side resonance circuit 51, and the power reception side resonance circuit 51 receives power through the magnetic field from the power transmission side resonance circuit 43.

The power reception side rectification circuit 54 is electrically connected to the power reception side resonance circuit 51 and the charging circuit 55. The power reception side rectification circuit 54 rectifies the alternating current power supplied from the power reception side resonance circuit 51 to convert it to direct current power and supplies the direct current power to the charging circuit 55. The power reception side rectification circuit 54 is, for example, an AC/DC converter.

The charging circuit 55 is electrically connected to the power reception side rectification circuit 54 and the battery 32. The charging circuit 55 converts the direct current power supplied from the power reception side rectification circuit 54 to the voltage level of the battery 32 and supplies it to the battery 32. If the power transmitted from the power transmission apparatus 4 is supplied by the power reception apparatus 5 to the battery 32, the battery 32 is charged and the state of charge of the battery 32 is restored. The charging circuit 55 is, for example, a DC/DC converter.

The ECU 7 performs various control of the vehicle 3. For example, the ECU 7 is electrically connected to the charging circuit 55 of the power reception apparatus 5 and controls the charging circuit 55 so as to control the charging of the battery 32 by power transmitted from the power transmission apparatus 4. Further, the ECU 7 is electrically connected to the PCU 33 and controls the PCU 33 to control the transfer of power between the battery 32 and vehicle-mounted equipment (for example, the motor 31).

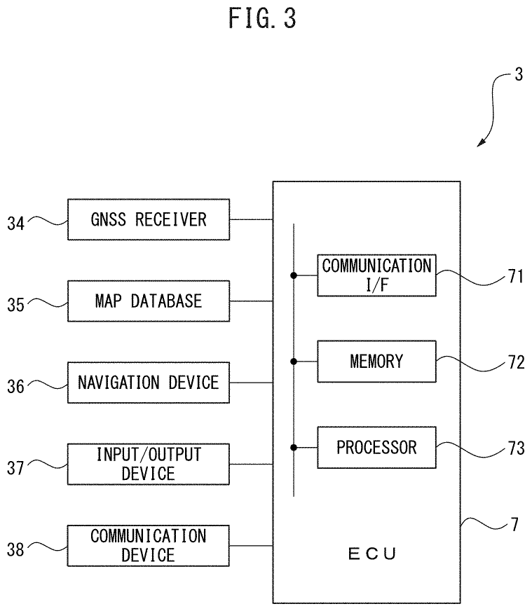

FIG. 3 is a view showing the schematic configuration of the ECU 7 and other vehicle-mounted equipment. The ECU 7 has a communication interface 71, a memory 72, and a processor 73. The communication interface 71, the memory 72, and the processor 73 are connected together through signal wires.

The communication interface 71 has an interface circuit for connecting the ECU 7 to an internal vehicle network based on the CAN (Controller Area Network) or other standard.

The memory 72, for example, has a volatile semiconductor memory (for example, RAM) and nonvolatile semiconductor memory (for example, ROM). The memory 72 stores programs to be run at the processor 73, various data used when various processing is performed by the processor 73, etc.

The processor 73 has one or more CPUs (central processing units) and their peripheral circuits and performs various processing. Note that, the processor 73 may have a logic unit or arithmetic unit or other such processing circuit.

Further, as shown in FIG. 3, the vehicle 3 is further provided with a GNSS receiver 34, a map database 35, a navigation device 36, an input/output device 37, and a communication device 38. The GNSS receiver 34, the map database 35, the navigation device 36, the input/output device 37, and the communication device 38 are electrically connected to the ECU 7.

The GNSS receiver 34 detects the current position of the vehicle 3 (for example, a latitude and a longitude of the vehicle 3) based on position measurement information obtained from a plurality of (for example, three or more) positioning satellites. Specifically, the GNSS receiver 34 captures a plurality of positioning satellites and receives signals emitted from the positioning satellites. Further, the GNSS receiver 34 calculates the distances to the positioning satellites based on the difference between the times of emission and times of reception of the signals and detects the current position of the vehicle 3 based on the distances to the positioning satellites and the positions of the positioning satellites (orbital information). The output of the GNSS receiver 34, that is, the current position of the vehicle 3 detected by the GNSS receiver 34, is sent to the ECU 7.

Note that, “GNSS” (Global Navigation Satellite System) is a general name of the GPS of the U.S., GLONASS of Russia, Galileo of Europe, QZSS of Japan, BeiDou of China, IRNSS of India, and other positioning satellite positioning systems. Therefore, the GNSS receiver 34 includes a GPS receiver.

The map database 35 stores map information. The map information includes position information of the power supply apparatuses 2. The ECU 7 acquires map information from the map database 35. Note that, the map database 35 may be provided outside of the vehicle 3 (for example, the server etc.), and the ECU 7 may acquire map information from outside the vehicle 3.

The navigation device 36 sets the running route of the vehicle 3 to the destination based on the current position of the vehicle 3 detected by the GNSS receiver 34, the map information of the map database 35, the input by the driver, etc. The running route set by the navigation device 36 is transmitted to the ECU 7. Note that, the GNSS receiver 34 and the map database 35 may be built into the navigation device 36.

The input/output device 37 performs input/output of information between the vehicle 3 and an occupant of the vehicle 3 (for example, the driver). The input/output device 37 includes, for example, a display for displaying information, a speaker for generating sound, operating buttons or operating switches for the occupant of the vehicle 3 to operate for input, a microphone for receiving the voice of the occupant of the vehicle 3, etc. The input/output device 37 is, for example, a human-machine interface (HMI) comprised of at least one of a touch screen, heads-up display, digital instrumentation panel, etc. The output of the ECU 7 is transmitted through the input/output device 37 to the occupant of the vehicle 3, while the input from the occupant of the vehicle 3 is transmitted through the input/output device 37 to the ECU 40. Note that, the navigation device 36 may function as an input/output device 37.

The communication device 38 is an equipment enabling communication between the vehicle 3 and the outside of the vehicle 3 (for example, near distance wireless communication module, data communication module (DCM) for connecting the vehicle 3 to a communication network such as the Internet, etc.). The ECU 7 communicates with the power supply apparatus 2 through the communication device 38.

As explained above, in the noncontact power supply system 1, noncontact power supply of the vehicle 3 is performed through an alternating current magnetic field generated at the power supply apparatus 2. However, constantly generating an alternating current magnetic field in the power supply apparatus 2 for noncontact power supply would waste power. Further, the effect of the alternating current magnetic field on the electronic equipment etc. is also a concern.

For this reason, when receiving a request for noncontact power supply from the vehicle 3, the controller 6 of the power supply apparatus 2 generates an alternating current magnetic field by the power transmission apparatus 4. By doing this, it is possible to generate an alternating current magnetic field at a suitable timing at which the vehicle 3 passes over the power supply apparatus 2.

For example, when the vehicle 3 approaches the power supply area at which the power supply apparatus 2 is arranged, the ECU 7 of the vehicle 3 requests the power supply apparatus 2 to supply power by a noncontact means. However, when the vehicle 3 passes over the power supply apparatus 2, an occupant of the vehicle 3 (for example, the driver) will not necessarily always desire charging of the battery 32 by a noncontact power supply. For example, if the amount of power stored by the battery 32 is sufficient or if charging of the battery 32 by an outside power source or regenerated power is scheduled, there is low need for supplying power from the power supply apparatus 2 to the vehicle 3. In particular, if a charge is levied against the vehicle 3 for utilization of a noncontact power supply, it is desirable to avoid unneeded power supply as much as possible.

For this reason, in the present embodiment, the intention to utilize a noncontact power supply is confirmed with the occupant of the vehicle 3, and it is judged whether to perform noncontact power supply based on the result of confirmation of the intention to utilize. Such control is performed by the ECU 7 of the vehicle 3. The ECU 7 is one example of a power supply control device provided at the vehicle 3.

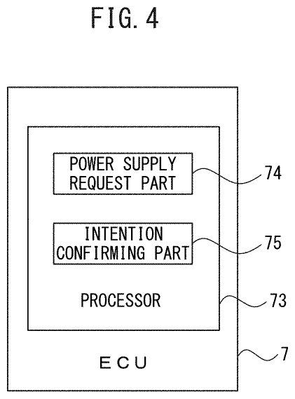

FIG. 4 is a functional block diagram of the processor 73 of the ECU 7. In the present embodiment, the processor 73 is provided with a power supply request part 74 and an intention confirming part 75. The power supply request part 74 and the intention confirming part 75 are functional modules realized by a computer program stored in the memory 72 of the ECU 7 run by the processor 73 of the ECU 7. Note that, the power supply request part 74 and the intention confirming part 75 may be realized by dedicated processing circuits provided at the processor 73.

The power supply request part 74 requests noncontact power supply from the power supply apparatus 2 to the vehicle 3. For example, the power supply request part 74 requests noncontact power supply by transmitting to the power supply apparatus 2 a proximity signal showing the approach of the vehicle 3 to the power supply apparatus 2.

The intention confirming part 75 confirms the intention to utilize a noncontact power supply from the power supply apparatus 2 to the vehicle 3 with the occupant of the vehicle 3. Further, if the occupant of the vehicle 3 does not have the intention to utilize the noncontact power supply, the power supply request part 74 stops the request for noncontact power supply from the power supply apparatus 2 to the vehicle 3. By doing this, it is possible to keep noncontact power supply from the power supply apparatus 2 to the vehicle 3 being performed contrary to the intention of the occupant of the vehicle 3.

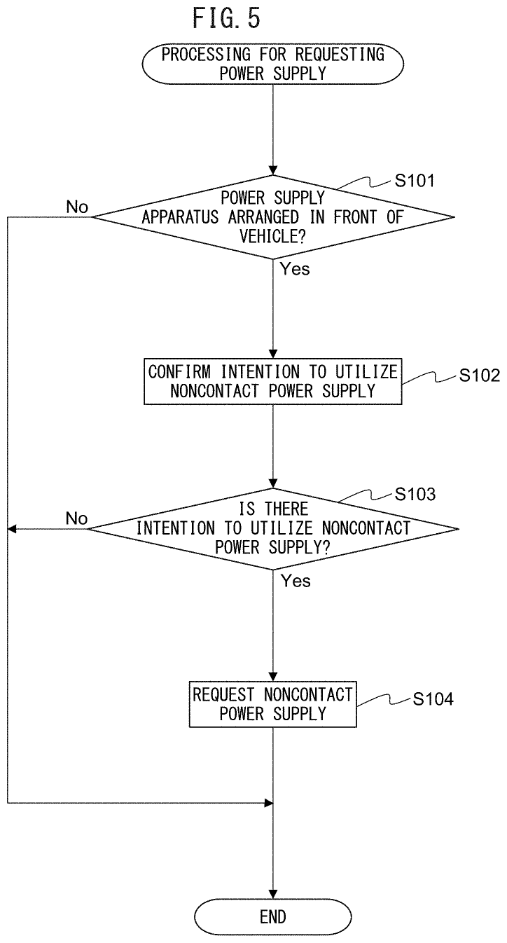

Below, referring to the flow chart of FIG. 5, the flow of the above-mentioned control will be explained. FIG. 5 is a flow chart showing a control routine of processing for requesting power supply in the first embodiment of the present disclosure. The present control routine is repeatedly performed by the processor 73 of the ECU 7.

First, at step S101, the intention confirming part 75 judges whether there is a power supply apparatus 2 arranged in front of the vehicle 3. That is, the intention confirming part 75 judges whether there is a power supply area in front of the vehicle 3. For example, if the power supply apparatus 2 is arranged in front of the vehicle 3 in the running lane of the vehicle 3, the intention confirming part 75 judges that the power supply apparatus 2 is arranged in front of the vehicle 3. Further, if the running route of the vehicle 3 has been set by the navigation device 36, when the distance between the power supply apparatus 2 arranged on the running route of the vehicle 3 and the vehicle 3 becomes equal to or less than a predetermined value, the intention confirming part 75 may judge that a power supply apparatus 2 is arranged in front of the vehicle 3. The distance between the power supply apparatus 2 and the vehicle 3 is for example calculated by comparing the position of the power supply apparatus 2 stored in the map database with the current position of the vehicle 3 detected by the GNSS receiver 34.

If at step S101 it is judged that the power supply apparatus 2 is not arranged in front of the vehicle 3, the present control routine ends. On the other hand, if at step S101 it is judged that the power supply apparatus 2 is arranged in front of the vehicle 3, the present control routine proceeds to step S102.

At step S102, the intention confirming part 75 confirms the intention to utilize a noncontact power supply from the power supply apparatus 2 to the vehicle 3 with the occupant of the vehicle 3. For example, the intention confirming part 75 confirms the intention to utilize a noncontact power supply with the occupant of the vehicle 3 through the input/output device 37. As a specific example, the intention confirming part 75 makes the input/output device 37 output a screen for confirming the intention to utilize a noncontact power supply with the occupant of the vehicle 3.

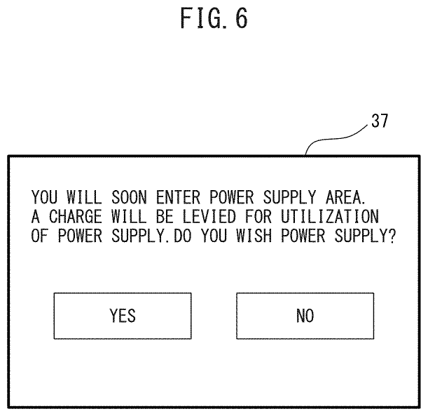

FIG. 6 is a view showing one example of a screen for confirming an intention to utilize a noncontact power supply with the occupant of a vehicle 3. In the example of FIG. 6, the occupant of the vehicle 3 operates a touch screen of the input/output device 37 to select whether or not he/she has an intention to utilize a noncontact power supply. The result of selection is then sent to the ECU 7.

Note that, the intention confirming part 75 may make the input/output device 37 output voice for confirming the intention to utilize a noncontact power supply with the occupant of the vehicle 3. In this case, the occupant of the vehicle 3 inputs to the input/output device 37 by voice whether or not he/she has an intention to utilize a noncontact power supply. Further, the intention confirming part 75 may make the input/output device 37 output a screen and voice for confirming the intention to utilize a noncontact power supply with the occupant of the vehicle 3. That is, the input/output device 37 outputs at least one of a screen and voice for confirming the intention to utilize a noncontact power supply with the occupant of the vehicle 3.

Further, the intention confirming part 75 may confirm the intention to utilize a noncontact power supply with the occupant of the vehicle 3 through a mobile terminal of the occupant of the vehicle 3. In this case, the mobile terminal of the occupant of the vehicle 3 and the ECU 7 are connected by cable or wirelessly, and the intention confirming part 75 makes the mobile terminal output at least one of a screen and voice for confirming the intention to utilize a noncontact power supply with the occupant of the vehicle 3.

Next, at step S103, the power supply request part 74 judges whether the occupant of the vehicle 3 has the intention to utilize a noncontact power supply. If it is judged there is no intention to utilize a noncontact power supply, the present control routine ends. That is, when the vehicle 3 passes over the power supply apparatus 2, the power supply request part 74 does not request the power supply apparatus 2 to provide noncontact power supply. As a result, no alternating current magnetic field is generated at the power transmission apparatus 4 of the power supply apparatus 2, and no charge for utilization of a noncontact power supply is generated.

On the other hand, if at step S103 it is judged that there is an intention to utilize a noncontact power supply, the present control routine proceeds to step S104. At step S104, the power supply request part 74 requests the power supply apparatus 2 to provide supply power by a noncontact means. For example, the power supply request part 74 sends a proximity signal through the communication device 38 of the vehicle 3 to the power supply apparatus 2 so as to request supply of power by a noncontact means. Note that, the power supply request part 74 may generate an alternating current magnetic field etc. at the vehicle 3 to request supply of power by a noncontact means. After step S104, the present control routine ends.

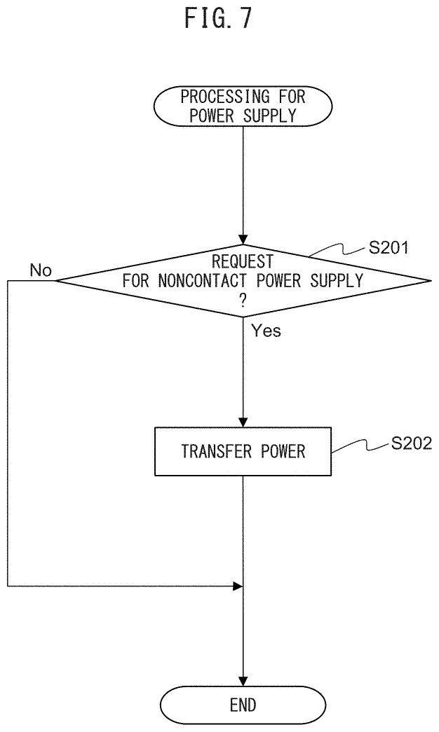

On the other hand, at the power supply apparatus 2, the following control is performed. FIG. 7 is a flow chart showing a control routine of processing for power supply in the first embodiment of the present disclosure. The present control routine is repeatedly performed by the processor 62 of the controller 6.

First, at step S201, the processor 62 judges whether there is a request for noncontact power supply from the vehicle 3. If it is judged that there is no request for noncontact power supply, the present control routine ends. On the other hand, if it is judged that there is a request for noncontact power supply, the present control routine proceeds to step S202.

At step S202, the processor 62 transfers power from the power supply apparatus 2 to the vehicle 3. Specifically, the processor 62 controls the inverter 42 of the power transmission apparatus 4 to supply high frequency power to the power transmission side resonance circuit 43. As a result, an alternating current magnetic field is generated at the power transmission side resonance circuit 43, and power is transferred through the alternating current magnetic field from the power transmission side resonance circuit 43 to the power reception side resonance circuit 51. After step S202, the present control routine ends.

### Second Embodiment

The configuration and control of the noncontact power supply system according to a second embodiment are basically similar to the configuration and control of the noncontact power supply system according to the first embodiment except for the points explained below. For this reason, below, the second embodiment of the present disclosure will be explained centered on the parts different from the first embodiment.

Whether or not noncontact power supply is necessary from the power supply apparatus 2 to the vehicle 3 changes according to the remaining amount of power stored in the battery 32 of the vehicle 3, the charging plan for the battery 32, etc. For this reason, in the second embodiment, when confirming the intention to utilize the noncontact power supply with the occupant of the vehicle 3, the intention confirming part 75 notifies information relating to the state of charge of the battery 32 of the vehicle 3 to the occupant of the vehicle 3. By doing this, it becomes possible for the occupant of the vehicle 3 to suitably judge whether or not to request a noncontact power supply.

For example, when confirming the intention to utilize a noncontact power supply with the occupant of the vehicle 3, the intention confirming part 75 notifies the current SOC of the battery 3 as information relating to the current state of charge of the battery 32 to the occupant of the vehicle 3. In this case, if the current SOC of the battery 32 is a sufficient value with respect to the running plan of the vehicle 3, the occupant of the vehicle 3 can reject the noncontact power supply of the vehicle 3 to prevent a charge for utilization of a noncontact power supply from being levied.

Further, when confirming the intention to utilize the noncontact power supply with the occupant of the vehicle 3, the intention confirming part 75 may notify at least one of the distance to a predetermined charging facility (for example, the home) and the predicted amount of consumption of power to be consumed until the vehicle 3 reaches the predetermined charging facility as information relating to the future state of charge of the battery 32 to the occupant of the vehicle 3. The predetermined charging facility is registered in advance by the occupant of the vehicle 3 using the input/output device 37 etc. In this case, if it is judged based on this information that charging of the battery 32 is not necessary, the occupant of the vehicle 3 can reject noncontact power supply of the vehicle 3 to prevent a charge for utilization of a noncontact power supply from being levied.

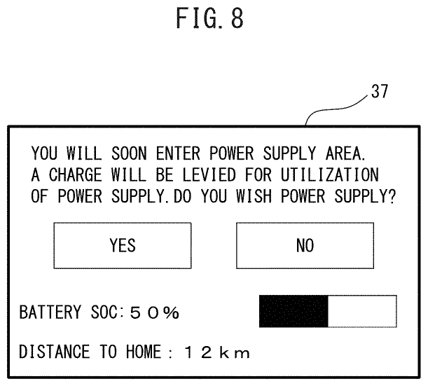

In the second embodiment, in the same way as the first embodiment, the control routine of processing for requesting power supply of FIG. 5 is performed. At this time, at step S102, the intention confirming part 75 makes the input/output device 37 output a screen such as shown in FIG. 8 as the screen for confirming the intention to utilize a noncontact power supply with the occupant of the vehicle 3.

FIG. 8 is a view showing one example of a screen for confirming an intention to utilize a noncontact power supply by the occupant of a vehicle 2. In the example of FIG. 8, the current SOC of the battery 32 and the distance from the current location to the home (predetermined charging facility) are displayed at the input/output device 37. Further, the current SOC of the battery 32 is displayed in the form of numerical values and a bar graph. Note that, the input/output device 37 may output the current SOC of the battery 32 and the distance from the current location to a predetermined charging facility by voice or screen and voice.

### Third Embodiment

The configuration and control of the noncontact power supply system according to a third embodiment are basically similar to the configuration and control of the noncontact power supply system according to the first embodiment except for the points explained below. For this reason, below, the third embodiment of the present disclosure will be explained centered on the parts different from the first embodiment.

In the third embodiment, if the occupant of the vehicle 3 does not have the intention to utilize a noncontact power supply, the power supply request part 74 of the ECU 7 sends a signal showing that the occupant of the vehicle 3 does not have the intention to utilize the noncontact power supply (below, referred to as a “utilization rejection signal”) to the power supply apparatus 2. Further, when receiving a utilization rejection signal, the processor 62 of the controller 6 stops the noncontact power supply from the power supply apparatus 2 to the vehicle 3.

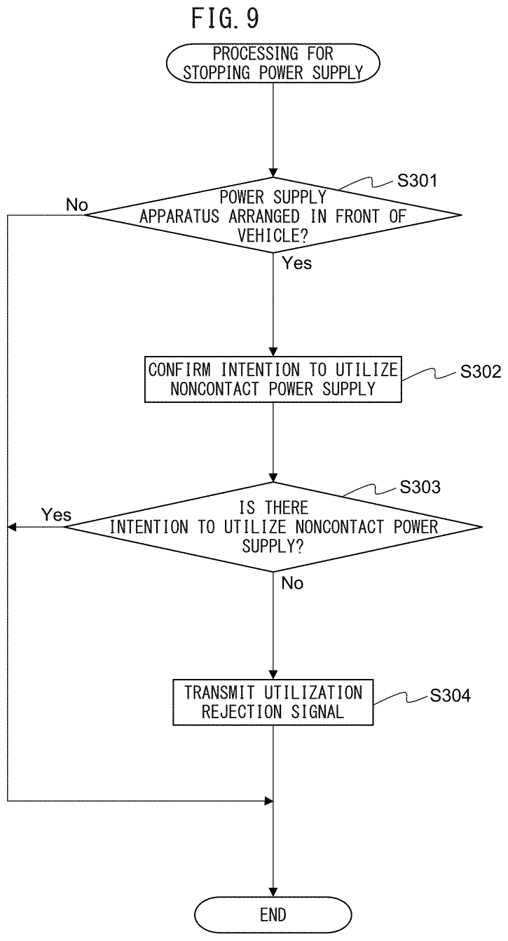

FIG. 9 is a flow chart showing a control routine of processing for stopping power supply in the third embodiment of the present disclosure. The present control routine is repeatedly performed by the processor 73 of the ECU 7.

Steps S301 to S303 are performed in the same way as steps S101 to S103 of FIG. 5. If at step S303 it is judged that there is an intention to utilize a noncontact power supply, the present control routine ends. On the other hand, if at step S303 it is judged that there is no intention to utilize a noncontact power supply, the present control routine proceeds to step S304.

At step S304, the power supply request part 74 sends a utilization rejection signal through the communication device 38 of the vehicle 3 to the power supply apparatus 2. After step S304, the present control routine ends.

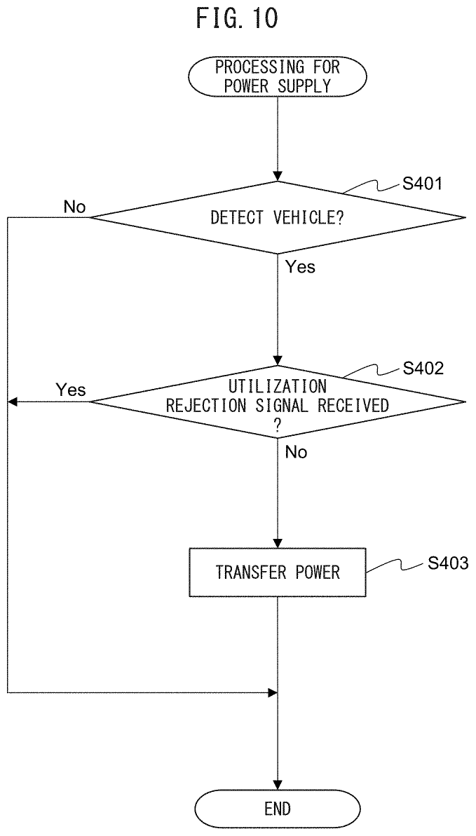

FIG. 10 is a flow chart showing a control routine of processing for power supply in the third embodiment of the present disclosure. The present control routine is repeatedly performed by the processor 62 of the controller 6.

First, at step S401, the processor 62 judges whether it has detected the vehicle 3. For example, the processor 62 uses a metal detector or photoelectric sensor (for example, a diffusion reflection type) or other such detector provided at the power supply apparatus 2 to detect the vehicle 3. Note that, a slight magnetic field (constant magnetic field or alternating current magnetic field) may be constantly emitted from the vehicle 3, and the processor 62 may detect such a magnetic field to detect the vehicle 3. Further, the processor 62 may detect the vehicle 3 by object recognition using a camera provided at the power supply apparatus 2 (for example, object recognition by machine learning etc.)

If at step S401 it is judged that the vehicle 3 has not been detected, the present control routine ends. On the other hand, if at step S401 it is judged that the vehicle 3 has been detected, the present control routine proceeds to step S402.

At step S402, the processor 62 judges whether it has received a utilization rejection signal from the vehicle 3. If it is judged that it has received a utilization rejection signal, the present control routine ends. In this case, the processor 62 does not perform noncontact power supply from the power supply apparatus 2 to the vehicle 3 when the vehicle 3 passes over the power supply apparatus 2.

On the other hand, if at step S402 it is judged that it has not received a utilization rejection signal, the present control routine proceeds to step S403. At step S403, in the same way as step S202 of FIG. 7, the processor 62 transfers power from the power supply apparatus 2 to the vehicle 3. After step S403, the present control routine ends.

### OTHER EMBODIMENTS

Above, preferred embodiments according to the present disclosure were explained, but the present disclosure is not limited to these embodiments and can be corrected and changed in various ways within the language of the claims.

For example, the vehicle 3 may be a hybrid vehicle (HV) or a plug-in hybrid vehicle (PHV) provided with an internal combustion engine and a motor as power sources for driving. Further, the vehicle 3 may be an automated driving vehicle in which at least a part of the acceleration, steering, and deceleration (braking) of the vehicle 3 is automatically controlled. Further, the vehicle 3 may be a commercial vehicle such as a bus or truck, an automated guide vehicle (AGV), etc.

Further, the method of noncontact power supply from the power supply apparatus 2 to the vehicle 3 is not limited to an electromagnetic induction system including a magnetic field resonance system, and various methods such as the magnetic field coupling system of transferring power using a magnetic field as the medium can be used.

Further, the above embodiments can be freely combined. For example, at step S302 of the processing for stopping power supply of FIG. 9, in the same way as the second embodiment, the intention confirming part 75 may output to the input/output device 37 a screen such as shown in FIG. 8 as the screen for confirming the intention to utilize the noncontact power supply with the occupant of the vehicle 3.

### REFERENCE SIGNS LIST

1. noncontact power supply system
2. power supply apparatus
3. vehicle
6. controller
62. processor
7. electronic control unit
73. processor
74. power supply request part
75. intention confirming part
37. input/output device

1. A power supply control device provided at a vehicle configured to be supplied with power from a power supply apparatus by a noncontact means, comprising a processor configured to:
request noncontact power supply from the power supply apparatus to the vehicle;
confirm an intention to utilize a noncontact power supply with an occupant of the vehicle, and
stop the request for noncontact power supply if the occupant does not have the intention to utilize.

2. The power supply control device according to claim 1, wherein when confirming the intention to utilize with the occupant, the processor is configured to notify the occupant of information relating to a state of charge of a battery of the vehicle.

3. The power supply control device according to claim 2, wherein when confirming the intention to utilize with the occupant, the processor is configured to notify the occupant of a current state of charge of the battery.

4. The power supply control device according to claim 2, wherein when confirming the intention to utilize with the occupant, the processor is configured to notify the occupant of at least one of a distance to a predetermined charging facility and a predicted amount of consumption of power consumed until the vehicle reaches the predetermined charging facility.

5. The power supply control device according to claim 3, wherein when confirming the intention to utilize with the occupant, the processor is configured to notify the occupant of at least one of a distance to a predetermined charging facility and a predicted amount of consumption of power consumed until the vehicle reaches the predetermined charging facility.

6. A power supply apparatus configured to supply power to a vehicle by a noncontact means, comprising:
a processor configured to control noncontact power supply from a power supply apparatus to the vehicle, wherein
the processor is configured to stop the noncontact power supply when receiving a signal indicating an occupant of the vehicle has no intention to utilize noncontact power supply.

7. An input/output device provided in a vehicle configured to be supplied with power from a power supply apparatus by a noncontact means,
the input/output device outputting at least one of a screen and a voice for confirming an intention to utilize a noncontact power supply from the power supply apparatus to the vehicle with an occupant of the vehicle.
